(19) United States
(12) Patent Application Publication
(10) Pub. No.: US 2008/0282656 A1
(43) Pub. Date: Nov. 20, 2008

(54) ROTATING FILAMENT SEPARATOR

(75) Inventor: Steven Mark Probst, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Sage Environmental Consulting, Inc., Austin, TX (US)

(21) Appl. No.: 12/121,949

(22) Filed: May 16, 2008

Related U.S. Application Data
(60) Provisional application No. 60/938,375, filed on May 16, 2007.

(51) Int. Cl. B01D 46/28

(52) U.S. Cl. 55/477

(57) ABSTRACT

In accordance with the present invention, a filter with rotating filaments, also referred to herein as a rotating filament separator, collects solid and liquid particulates in a gas stream. The filaments rotate at a high speed in a plane that is approximately perpendicular to the direction of flow of the gas stream. The rotating filaments collect particulates suspended in the gas stream through the impaction of the particulates onto the rotating filaments. In particular, the rotating filaments can collect particulates through impaction by changing the velocity of the flow of the particulates from a velocity with a direction that is approximately perpendicular to the plane of rotation of the rotating filaments to a velocity with a radial direction that is approximately parallel to the plane of rotation of the rotating filaments. In one preferred embodiment, the particulates attain a radial velocity flow, in a highly-concentrated, low-volume-flow aerosol stream, to an air-swept, circumferential chamber.

### CROSS-REFERENCE TO RELATED APPLICATIONS

This non-provisional application claims priority based upon prior U.S. Provisional Patent Application Ser. No. 60/938,375 filed May 16, 2007 in the name of Steven Mark Probst, entitled “Rotating Separator,” the disclosure of which is incorporated herein by reference.

### BACKGROUND OF THE INVENTION

The present invention is related generally to air filtering and, more particularly, to the use of moving filaments to remove particulates from air streams.

The collection of particulates, such as particles and/or droplets, from air streams is typically achieved with deep bed filament filters, such as industrial bag-houses using cloth filter media. Deep bed filament filters depend primarily upon molecular attraction, in particular van der Waals forces, for particulate collection. For example, deep bed filament filters typically employ van der Waals forces to retain small particulates on larger filament surfaces by entrapment of the particulates in the inter-filament spaces in a filament mat. In addition, deep bed filament filters partially retain small particulates on larger filament surfaces by impaction. Impaction is essentially a process in which a particulate impacts a filament surface with an inertia that leads the particulate to either stick to the surface or bounce off the surface.

The efficiency with which a deep bed filament filter collects particulates is generally dependent upon the projected geometric area of all its filaments. Increasing the diameter of each filament or the number of filaments of a deep bed filament filter increases its projected geometric area. However, it is often desirable to limit the size of the diameter of a deep bed filament filter to, for example, reduce cost or to accommodate certain physical size restraints. At the same time, increasing the projected geometric area of a deep bed filament filter by increasing the number of filaments can result in greater impedance of the air flow to the deep bed filament filter, resulting in high operating, maintenance, and cleaning costs. In fact, the cleaning of a conventional deep bed filament filter can itself contribute to wear and is a major cause of unreliable operation.

Therefore, in light of the necessity of removing particulates from air streams, it can be appreciated that there is a significant need for a separator that will collect particulates from air streams more efficiently than a deep bed filament filter without presenting the problems discussed above associated with increasing diameter size or the number of filaments. It can be further appreciated that there is a significant need for a separator that has lower power requirements, is more robust and reliable, and requires less maintenance than a deep bed filament filter. The present invention provides these and other advantages, as will be apparent from the following detailed description and accompanying figures.

### BRIEF SUMMARY OF THE INVENTION

In accordance with the present invention, a filter with rotating filaments, also referred to herein as a rotating filament separator, collects solid and liquid particulates in a gas stream. The filaments rotate at a high speed in a plane that is approximately perpendicular to the direction of flow of the gas stream. The rotating filaments collect particulates suspended in the gas stream through the impaction of the particulates onto the rotating filaments. In particular, the rotating filaments can collect particulates through impaction by changing the velocity of the flow of the particulates from a velocity with a direction that is approximately perpendicular to the plane of rotation of the rotating filaments to a velocity with a radial direction that is approximately parallel to the plane of rotation of the rotating filaments. In one preferred embodiment, the particulates attain a radial velocity flow, in a highly-concentrated, low-volume-flow aerosol stream, to an air-swept, circumferential chamber.

The following are design parameters of a preferred embodiment of the present invention: (i) air stream velocity; (ii) air stream volume flow rate; (iii) duct diameter; (iv) rotational speed; (v) filament tip velocity; (vi) materials of construction; (vii) mechanical design; (viii) footprint considerations; (ix) filament diameter; and (x) physical and chemical characteristics of the particulate and droplets entrained in the air stream.

In a preferred embodiment of the present invention, the rotating filament separator has the following features and attributes: (i) the total gas flow rate through the rotating filament separator is approximately 50,000 cubic feet per minute; (ii) the duct diameter that contains the rotating filament separator is approximately 3 feet; (iii) the rotating filament separator has a brush hub diameter of approximately 1 foot; (iv) the area of a cross-section of the duct that is open and generally perpendicular to the direction of flow is equal to approximately 6.28 square feet; (v) the rotational velocity of the rotating filaments of the rotating filament separator is approximately 3,600 revolutions per minute; (vi) the velocity of the portions of the rotating filaments that are closest to the axis of rotation of the rotating filaments is approximately 5,700 centimeters per second; (vii) the velocity of the portions of the rotating filaments that are farthest from the axis of rotation of the rotating filaments is approximately 17,200 centimeters per second; (viii) the weighted average velocity of the rotating filaments is approximately 12,500 centimeters per second; (ix) the diameters of the rotating filaments fall within the range of 0.1 millimeters to 2.0 millimeters; and (x) the average particulate density is approximately 2.7 grams per cubic centimeter.

### BRIEF DESCRIPTION OF THE DRAWINGS

FIG. 1 is a graphical illustration of single filament impaction efficiency as a function of particulate size and filament diameter in a preferred embodiment of the present invention.

FIG. 2 is a graphical illustration of system impaction efficiency as a function of particulate size and filament diameter in a preferred embodiment of the present invention.

FIG. 3 is a graphical illustration of the dependence of impaction efficiency on particulate diameter in preferred embodiments of the present invention.

FIG. 4 is a graphical illustration of the dependence of system impaction efficiency on particulate diameter in preferred embodiments of the present invention with equal impaction areas.

### DETAILED DESCRIPTION

In accordance with the present invention, a filter with rotating filaments, also referred to herein as a rotating filament separator, collects solid and liquid particulates in a gas stream. The filaments rotate at a high speed in a plane that is approximately perpendicular to the direction of flow of the gas stream. The rotating filaments collect particulates suspended in the gas stream through the impaction of the particulates onto the rotating filaments. In particular, the rotating filaments can collect particulates through impaction by changing the velocity of the flow of the particulates from a velocity with a direction that is approximately perpendicular to the plane of rotation of the rotating filaments to a velocity with a radial direction that is approximately parallel to the plane of rotation of the rotating filaments. In one preferred embodiment, the particulates attain a radial velocity flow, in a highly-concentrated, low-volume-flow aerosol stream, to an air-swept, circumferential chamber. This radial velocity flow may be discharged or subjected to additional means of aerosol collection.

The spacing between the rotating filaments of the rotating filament separator is typically orders of magnitudes larger than the diameters of the particulates that are impacted by the filaments. Consequently, the rotating filament separator does not rely on entrapment or van der Waals force effects to collect particulates like a deep bed filament filter. As a result, the rotating filament separator is more efficient than a deep bed filament filter. For example, the particulates collected in a deep bed filament filter by entrapment increase the area of obstruction to the gas stream flowing through the filter and, hence, impede the flow of the gas stream. Such impedance to gas stream flow due to particulate loading does not occur with the rotating filament separator since the rotating filament separator does not collect particulates by entrapment.

At the same time, the rotating filament separator is also more efficient than a deep bed filament filter because a deep bed filter with an equivalent filtering area to that of a rotating filament separator has a much greater impedance to air stream flow. The effective impaction area of the rotating filament separator is equivalent to the arc swept by the filaments in the time the gas stream flow moves a distance that is equal to the thickness of the filaments. Since the filaments of a deep bed filament filter do not move, however, a deep bed filament filter must have a larger actual projected area of filament to have an equivalent impaction area to that of the rotating filament separator. In other words, the deep bed filament filter must have a larger diameter or a larger number of filaments and, as discussed above, additional filaments in a deep bed filament filter causes increased impedance to gas stream flow and, consequently, decreased efficiency. Since impedance to gas stream flow is directly proportional to the power consumption needed to operate a filter, the rotating filament separator is more energy efficient than a deep bed filament filter.

The following are design parameters of a preferred embodiment of the present invention: (i) air stream velocity; (ii) air stream volume flow rate; (iii) duct diameter; (iv) rotational speed; (v) filament tip velocity; (vi) materials of construction; (vii) mechanical design; (viii) footprint considerations; (ix) filament diameter; and (x) physical and chemical characteristics of the particulate and droplets entrained in the air stream. Each of these design parameters is discussed in more detail below.

Air Stream Velocity: Air stream velocity is generally the most important single criterion determining the applicability of a rotating filament separator for particulate control. The filaments must sweep an entire volume of air more than once in order to achieve removal efficiencies approaching 100%. The swept volume at a given air stream velocity can be determined by the rotational speed and the number and diameter of the filaments. The upper limit of rotational speed is governed by tip speed which can be determined by both filament speed and filament length. Factors determinate of maximum tip speed include vibration of the filaments, the mechanical properties of the filaments and filament diameter. In industrial applications, exhaust stream velocities rarely exceed 100 feet per second. In one embodiment, for example, the rotating filament separator passes 50,000 cubic feet per minute of gas through a brush of 3.5 feet in diameter and having a hub 1 foot in diameter. This embodiment gives the brush an area of 8.8 square feet, a linear air stream velocity of 100 feet per second and a filament length of 1.25 feet. At this velocity the air stream advances 1 millimeter in 0.000033 seconds. A single filament would be required to rotate at 30,500 revolutions per second to sweep a 1 millimeter thick slice of the air stream once in 0.000033 seconds. A brush having 5,000 filaments, however, will only be required to rotate at 1/5,000 the speed of a single filament, or 366 revolutions per minute, to sweep the same 1 millimeter thick slice. In other words, a brush with 5,000 filaments each having a 1.0 millimeter diameter and rotating at 366 revolutions per minute will sweep a volume of 52,821 cubic feet per minute. The sweep volume can be calculated from the following equation: (366 revolutions per minute)×(8.8 ft² brush area)×(5,000 filaments)×(0.00328 feet filament diameter).

In the above embodiment, the rotating filament separator has 100% predicted impaction efficiency at 366 revolutions per minute. Actual separation efficiencies are typically less than predicted impaction efficiencies. Actual separation efficiencies may be increased to equal predicted impaction efficiency values, however, if the number of impaction events is increased by increasing the number of filaments or increasing the rotational velocity. In the above embodiment, for example, increasing the rotational velocity from 366 revolutions per minute to 3,000 revolutions per minute will ensure that the actual separation efficiency approaches the theoretically predicted impaction efficiency of 100%.

Air stream velocity is also influenced by the thickness of the brush. In one embodiment, the brush contains 36 filaments in each plane of the brush, each mounted with a 10° angular separation. With a rotational velocity of 3,000 revolutions per minute, this embodiment will have 1,800 filament revolutions per second. The time for any one filament to sweep the volume between filaments is 0.000556 sec. Since the air stream advances 1 millimeter in 0.000033 seconds a total of 16.8 filaments will be required in each row along the thickness of the brush. In other words, the brush must have a minimum of 606 filaments. In this embodiment, the number of filaments, 5,000, allows for the increase in separation efficiency as discussed above. A brush with 5,000 filaments divided into 36 rows yields approximately 140 filaments per row. If the filament separation is chosen to approximately equal to the filament thickness, the length of each row of filaments will approximately be 280 millimeters or 11 inches.

Air Stream Volume Flow Rate: In industrial applications duct diameters are selected to limit the gas velocity, the system back pressure and noise generation. As stated above, typical gas velocities are in the range of 50 feet per second. Rarely are velocities encountered greater than 100 feet per second. Thus, large volume flow rates are usually associated with large duct diameters and with large emission control devices.

Duct Diameter: In conventional industrial emission control systems the ducting is not an active component in the control strategy and the duct diameter is, therefore, inconsequential in the overall design of the control device. In the case of the rotating filament separator, however, duct diameter is an important design parameter because brush size, and, more particularly, the length of a brush's filaments, is dependent on duct diameter. Large ducts require long filaments and, in some applications, long filaments can lead to mechanical problems with tip velocity, vibration, and tensile strength. Consequently, duct diameter, and hence volume flow rate of a rotational filament separator, is generally limited by the length of a brush's filaments. In one embodiment of the present invention, however, multiple rotating filament separators operate in sequence to accommodate large volume flow rates within large ducts.

Rotational Speed: Electric motors and associated mechanical components having rotational speeds of 3,600 revolutions per minute are commercially available. Electric motors and associated mechanical components operating at higher speeds are less common and often require special considerations with regard to bearings, balance and foundations. A preferred embodiment of the present invention has a rotational velocity of 3,000 revolutions per minute.

Filament Tip Velocity: In a preferred embodiment of the present invention with a rotational velocity of 3,000 revolutions per minute, the filament tips rotate at 3,000 revolutions per minute at a distance of 3.5 ft from the axis of rotation. Consequently, the linear tip velocity is approximately 17,000 centimeters per second.

Materials of Construction: Materials of construction, especially of the filaments, must be chosen to take account of the mechanical requirements associated with tensile strength, vibration and temperature. Erosion, corrosion and chemical attack by particulate and gaseous components in the gas stream must also be considered in selection of filament materials. The attachment of the filaments to the brush hub also influence, in part, the selection of filament materials. A preferred embodiment of the present invention employs filaments of phosphor bronze and stainless steel to allow operation of filaments in erosive and corrosive environments with high tip velocities and high temperatures. In other embodiments, the filaments are composed of plastic components such as nylon, Teflon, polypropylene or polyethylene.

Discharge Design: The rotating filament separator may have a right-angle discharge with a centrifugal-styled discharge fan, or an in-line discharge.

Footprint Considerations: The rotating filament separator has a footprint that is smaller than any other control device of similar capacity. The rotating filament separator may be added to an existing fan, or placed in an existing duct, with only minor, if any, equipment relocation.

Filament Diameter: The selection of filament diameters is based upon the size of the particulates to be collected and upon the mechanical requirements of the filaments. Consequently, filament diameter, as discussed in more detail below, is often determined for each particular application.

Physical and Chemical Characteristics of Particulates, Droplets and Gases: The design of the rotating filament separator often depends on the physical and chemical properties of the particulate and droplet materials to be removed by a rotating filament separator as well as the gas containing such materials. For example, free flowing particulate, such as mineral dusts, are ideal candidates for removal by the present invention since they will not generally agglomerate or stick to the filaments and can be easily conveyed from the rotating filament separator to an air-flow discharge. Similarly, liquids of low viscosity, such as carry-over from scrubbers and spraying operations, may be centrifuged from the filaments and require no further treatment. On the other hand, ultra-fine or sticky particulates, such as organic chemicals and food products, may stick to the filaments and require the filaments to be repeatedly irrigated with a washing liquid. In addition, the resultant slurry may require special handling in a subsequent discharge air removal and collection system. Alternatively, if deposits form on the filaments through evaporation of liquids or by impaction of viscous liquids, such as oils and tars, liquid irrigation may also be required.

In a preferred embodiment of the present invention, the rotating filament separator has the following features and attributes: (i) the total gas flow rate through the rotating filament separator is approximately 50,000 cubic feet per minute; (ii) the duct diameter that contains the rotating filament separator is approximately 3 feet; (iii) the rotating filament separator has a brush hub diameter of approximately 1 foot; (iv) the area of a cross-section of the duct that is open and generally perpendicular to the direction of flow is equal to approximately 6.28 square feet; (v) the rotational velocity of the rotating filaments of the rotating filament separator is approximately 3,600 revolutions per minute; (vi) the velocity of the portions of the rotating filaments that are closest to the axis of rotation of the rotating filaments is approximately 5,700 centimeters per second; (vii) the velocity of the portions of the rotating filaments that are farthest from the axis of rotation of the rotating filaments is approximately 17,200 centimeters per second; (viii) the weighted average velocity of the rotating filaments is approximately 12,500 centimeters per second; (ix) the diameters of the rotating filaments fall within the range of 0.1 millimeters to 2.0 millimeters; and (x) the average particulate density is approximately 2.7 grams per cubic centimeter.

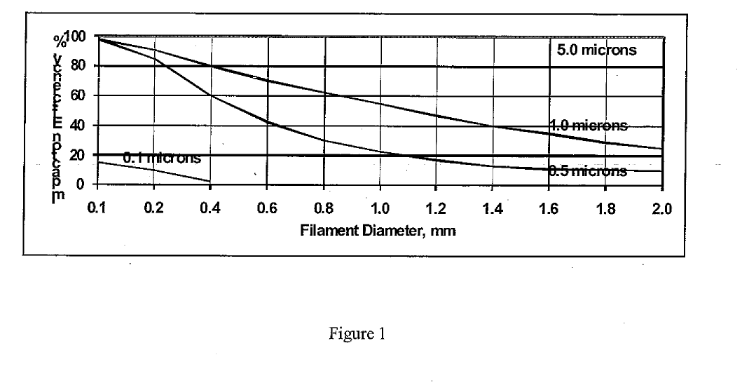

Referring now to FIG. 1, a graphical illustration of single filament impaction efficiency as a function of particulate size and filament diameter in a preferred embodiment of the present invention is shown. Single filament impaction efficiency is shown for particulates having diameters of 0.1, 0.5, 1.0 and 5.0 microns and rotating filaments with diameters ranging from 0.1 millimeters to 2.0 millimeters. Single filament impaction efficiency is shown to increase with increases in particulate size. At the same time, single filament impaction efficiency decreases with increases in the diameters of the rotating filaments.

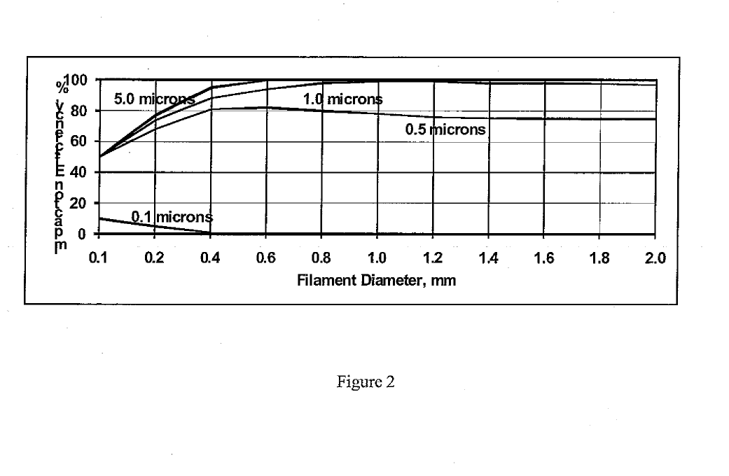

Referring now to FIG. 2, a graphical illustration of system impaction efficiency as a function of particulate size and filament diameter in a preferred embodiment of the present invention is shown. In this embodiment of the present invention, the brush containing the rotating filaments contains 100 rows of filaments with 50 filaments in each row. System impaction efficiency is shown for particulates having diameters of 0.1, 0.5, 1.0 and 5.0 microns and rotating filaments with diameters ranging from 0.1 millimeters to 2.0 millimeters. System impaction efficiency is shown to increase with increases in particulate size. At the same time, system impaction efficiency increases, for particulates having diameters of 0.5, 1.0 and 5.0 microns, with increases in the diameters of the rotating filaments with the ranges of 0.1 millimeters to approximately 0.6 millimeters for the 0.5 micron diameter particulates, approximately 1.1 millimeters for the 1.0 micron diameter particulates, and approximately 0.6 millimeters for the 5.0 micron diameter particulates. Increasing filament diameter more than the before mentioned upper range for each respective particulate size either does not increase, or slightly decreases, system impaction efficiency. With respect to particulates having diameters of 0.1 microns, system impaction efficiency decreases with increases in the diameters of the rotating filaments within the ranges of 0.1 millimeters to approximately 0.4 millimeters. Thereafter, the system impact efficiency is approximately zero.

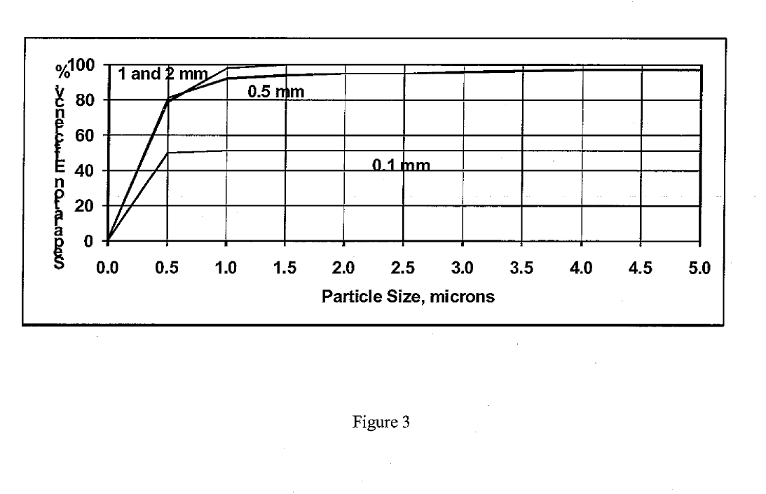

Referring now to FIG. 3, a graphical illustration of the dependence of impaction efficiency on particulate diameter in preferred embodiments of the present invention is shown. The data in FIG. 3 is equivalent to that in FIG. 2 but has been plotted to show the calculated impaction efficiencies of particulates of a specified diameter with filaments having diameters of 0.1, 0.5, 1.0 and 2.0 millimeters. It should be noted that FIG. 3 depicts the impaction efficiencies on the basis of 5,000 filaments. If the efficiency were calculated on an equal impaction area basis, the 0.1 millimeter filament data would show greater impaction efficiency than the 1.0 millimeter filament data.

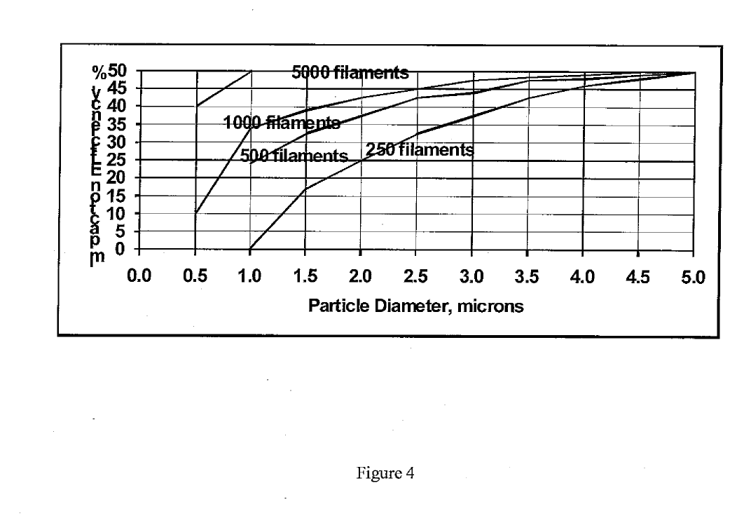

Referring now to FIG. 4, a graphical illustration of the dependence of system impaction efficiency on particulate diameter in preferred embodiments of the present invention with equal impaction areas is shown. FIG. 4 shows the impaction efficiencies calculated on the basis of equal impaction areas. The following brush configurations, each having identical impaction areas, are shown to demonstrate the relative efficiencies: (i) 5,000 filaments each having a 0.1 millimeter diameter; (ii) 1,000 filaments each having a 0.5 millimeter diameter; (iii) 500 filaments each having a 1.0 millimeter diameter; and (iv) 250 filaments each having a 2.0 millimeter diameter.

FIG. 3 and FIG. 4 show that if the brush configuration has 5,000 filaments, the impaction efficiency on 1-micron particulates is greater than 85% for filaments having diameters of 0.5 millimeter, 1.0 millimeter or 2.0 millimeters. On the other hand, if the brush configuration has 5,000 or less filaments each having a 0.1 millimeter diameter, the maximum impaction efficiency achievable for particulates smaller than 5-microns is 50%.

In another preferred embodiment of the present invention, the rotating filament separator has exhaust rates up to 50,000 cubic feet per minute and velocities as high as 100 feet per second. These specifications include a duct diameter of 3.5 feet, a 1 foot diameter brush hub, 5,000 filaments each having a diameter of 1 millimeter, a brush that is 11 inches thick and a rotational velocity of 3,000 revolutions per minute.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination.

It will be appreciated by persons skilled in the art that the present invention is not limited by what has been particularly shown and described hereinabove.

What is claimed is:

1. A rotating filament separator comprising:
a plurality of filaments wherein one end of each filament of said plurality of filaments is attached to the hub of a brush to form a brush; and
wherein said brush is contained within a duct and said plurality of filaments rotate around said hub of said brush with a rotational velocity in the range of 3000 to 3600 revolutions per minute and rotate in a plane that is approximately perpendicular to the principal direction of flow in said duct.

2. The rotating filament separator of claim 1 wherein said rotation of said plurality of filaments removes particulates from said flow.

3. The rotating filament separator of claim 2 wherein the spacing between said plurality of filaments is at least one order of magnitude greater than the average diameter of said particulates.

4. The rotating filament separator of claim 1 wherein particulates suspended in said flow impact said plurality of filaments.

5. The rotating filament separator of claim 4 wherein said impaction changes the velocity of said particulates from a velocity with a direction that is approximately perpendicular to said plane of rotation to a velocity with a radial direction that is approximately parallel to said plane of rotation.

6. The rotating filament separator of claim 1 further comprising an air-swept chamber wherein said plurality of filaments cause particulates to flow to said chamber for discharge or additional filtering.

7. The rotating filament separator of claim 6 wherein said air-swept chamber is located alongside said duct at a right angle to the longitudinal axis of said duct.

8. The rotating filament separator of claim 7 further comprising a centrifugal-styled discharge fan operating within said air-swept chamber.

9. The rotating filament separator of claim 6 wherein said air-swept chamber is located along the longitudinal axis of said duct.

10. The rotating filament separator of claim 1 wherein the volume of said flow is approximately equal to or less than 50,000 cubic feet per minute.

11. The rotating filament separator of claim 1 wherein the velocity of said flow is approximately equal to or less than 100 feet per second.

12. The rotating filament separator of claim 1 wherein said hub of said brush has a diameter that is approximately equal to one foot.

13. The rotating filament separator of claim 1 wherein said brush has a diameter that is approximately equal to 3.5 feet.

14. The rotating filament separator of claim 1 wherein said plurality of filaments is equal to approximately 5,000 filaments.

15. The rotating filament separator of claim 1 wherein each filament of said plurality of filaments has a diameter in the range of approximately 0.1 millimeters and approximately 2.0 millimeters.

16. The rotating filament separator of claim 1 wherein said plurality of filaments are attached to said hub of said brush in approximately 36 rows with approximately 140 filaments per row.

17. The rotating filament separator of claim 1 wherein said plurality of filaments are attached to said hub of said brush with an angular separation of approximately 10 degrees.

18. The rotating filament separator of claim 1 wherein said duct has a diameter in the range of approximately 3 feet to approximately 3.5 feet.

19. The rotating filament separator of claim 1 wherein the area of said duct that is open to flow that is equal to approximately 6.28 square feet.

20. The rotating filament separator of claim 1 wherein the material comprising said plurality of filaments includes phosphor bronze and stainless steel.

21. The rotating filament separator of claim 1 wherein the material comprising said plurality of filaments includes plastic.

22. The rotating filament separator of claim 1 wherein the material comprising said plurality of filaments includes at least one of nylon, Teflon, polypropylene or polyethylene.

23. The rotating filament separator of claim 1 wherein the velocity of the portion of said plurality of filaments that is closest to the axis of rotation of said brush is approximately 5,700 centimeters per second.

24. The rotating filament separator of claim 1 wherein the velocity of the portion of said plurality of filaments that is farthest from the axis of rotation of said brush is approximately 17,200 centimeters per second.

25. The rotating filament separator of claim 1 wherein the weighted average velocity of said plurality of filaments is approximately 12,500 centimeters per second.

26. The rotating filament separator of claim 1 wherein the velocity of the portion of said plurality of filaments that is closest to the axis of rotation of said brush is approximately 5,700 centimeters per second.

27. The rotating filament separator of claim 1 wherein said flow contains suspended particulates with an average density that is equal to approximately 2.7 grams per cubic centimeter.

28. The rotating filament separator of claim 1 wherein said flow contains suspended particulates wherein the majority of said suspended particulates have a diameter in the range of 0.1 microns to 5 microns.

29. The rotating filament separator of claim 1 wherein said rotating filament separator is comprised of more than one said plurality of filaments and said brush and said more than one said plurality of filaments and said brush operate in sequence.

30. A rotating filament separator comprising:
a plurality of filaments wherein one end of each filament of said plurality of filaments is attached to a hub of a brush to form a brush;
wherein said brush is contained within a duct, said plurality of filaments rotate around said hub of said brush in a plane that is approximately perpendicular to the principal direction of flow in said duct; and
wherein said plurality of filaments includes a number of filaments in the range of approximately 250 to approximately 5,000 and each filament of said plurality of filaments has a diameter in the range of approximately 0.1 millimeters and approximately 2.0 millimeters.

31. The rotating filament separator of claim 30 wherein said rotation of said plurality of filaments removes particulates from said flow.

32. The rotating filament separator of claim 31 wherein the spacing between said plurality of filaments is at least one order of magnitude greater than the average diameter of said particulates.

33. The rotating filament separator of claim 30 wherein particulates suspended in said flow impact said plurality of filaments.

34. The rotating filament separator of claim 33 wherein said impaction changes the velocity of said particulates from a velocity with a direction that is approximately perpendicular to said plane of rotation to a velocity with a radial direction that is approximately parallel to said plane of rotation.

35. The rotating filament separator of claim 30 further comprising an air-swept chamber wherein said plurality of filaments cause particulates to flow to said chamber for discharge or additional filtering.

36. The rotating filament separator of claim 35 wherein said air-swept chamber is located alongside said duct at a right angle to the longitudinal axis of said duct.

37. The rotating filament separator of claim 36 further comprising a centrifugal-styled discharge fan operating within said air-swept chamber.

38. The rotating filament separator of claim 35 wherein said air-swept chamber is located along the longitudinal axis of said duct.

39. The rotating filament separator of claim 30 wherein the volume of said flow is approximately equal to or less than 50,000 cubic feet per minute.

40. The rotating filament separator of claim 30 wherein the velocity of said flow is approximately equal to or less than 100 feet per second.

41. The rotating filament separator of claim 30 wherein said hub of said brush has a diameter that is approximately equal to one foot.

42. The rotating filament separator of claim 30 wherein said brush has a diameter that is approximately equal to 3.5 feet.

43. The rotating filament separator of claim 30 wherein said rotation has a rotational velocity in the range of approximately 3000 to approximately 3600 revolutions per minute.

44. The rotating filament separator of claim 30 wherein said plurality of filaments are attached to said hub of said brush in approximately 36 rows with approximately the same number of filaments per row.

45. The rotating filament separator of claim 30 wherein said plurality of filaments are attached to said hub of said brush with an angular separation of approximately 10 degrees.

46. The rotating filament separator of claim 30 wherein said duct has a diameter in the range of approximately 3 feet to approximately 3.5 feet.

47. The rotating filament separator of claim 30 wherein the area of said duct that is open to flow that is equal to approximately 6.28 square feet.

48. The rotating filament separator of claim 30 wherein the material comprising said plurality of filaments includes phosphor bronze and stainless steel.

49. The rotating filament separator of claim 30 wherein the material comprising said plurality of filaments includes plastic.

50. The rotating filament separator of claim 30 wherein the material comprising said plurality of filaments includes at least one of nylon, Teflon, polypropylene or polyethylene.

51. The rotating filament separator of claim 30 wherein the velocity of the portion of said plurality of filaments that is closest to the axis of rotation of said brush is approximately 5,700 centimeters per second.

52. The rotating filament separator of claim 30 wherein the velocity of the portion of said plurality of filaments that is farthest from the axis of rotation of said brush is approximately 17,200 centimeters per second.

53. The rotating filament separator of claim 30 wherein the weighted average velocity of said plurality of filaments is approximately 12,500 centimeters per second.

54. The rotating filament separator of claim 30 wherein the velocity of the portion of said plurality of filaments that is closest to the axis of rotation of said brush is approximately 5,700 centimeters per second.

55. The rotating filament separator of claim 30 wherein said flow contains suspended particulates with an average density that is equal to approximately 2.7 grams per cubic centimeter.

56. The rotating filament separator of claim 30 wherein said flow contains suspended particulates wherein the majority of said suspended particulates have a diameter in the range of 0.1 microns to 5 microns.

57. The rotating filament separator of claim 30 wherein said rotating filament separator is comprised of more than one said plurality of filaments and said brush and said more than one said plurality of filaments and said brush operate in sequence.
